(19) United States
(12) Patent Application Publication
(10) Pub. No.: US 2003/0024223 A1
(43) Pub. Date: Feb. 6, 2003

(54) Electric vehicle and reel mower gang

(76) Inventors: Willem Jager, Breslau (CA); Craig Shoemaker, Elora (CA)

Correspondence Address: RICHES McKENZIE & HERBERT LLP, SUITE 1800, 2 BLOOR STREET EAST, TORONTO, M4W 3J5, CA

(21) Appl. No.: 10/192,840

(22) Filed: Jul. 11, 2002

(30) Foreign Application Priority Data
Jul. 13, 2001 (CA) 2,352,993

(51) Int. Cl. A01D 75/30

(52) U.S. Cl. 56/7

(57) ABSTRACT

A novel construction for a body for a vehicle in which two elongate decks are provided supported in alignment one on top of the other and spaced from each other with rib members extending from each side of the decks outwardly to the side joining the sides of the decks and defining a cavity between the decks and inside the rib members. The ribs are preferably tubular members for strength but reduced weight.

### SCOPE OF THE INVENTION

This invention relates to an electric vehicle and, more particularly, to a construction for a vehicle. The invention also relates to a reel mower gang.

### BACKGROUND OF THE INVENTION

Known lawn riding tractors suffer many disadvantages. One disadvantage is that they typically do not provide adequate suspension and are uncomfortable to ride for extended periods, particularly, over rough terrain. Another disadvantage is that attachments such as power cutting decks are supported directly on the wheel axles without suspension resulting in the attachments necessarily absorbing jarring and impacts. Another disadvantage is that know vehicles do not have lightweight body frames adapted to support batteries.

Many reel mower gang assemblies are known. One disadvantage of many reel mower gangs is that they are not adapted to be pushed ahead of a vehicle. Another disadvantage is that the reel mowers can be damaged by engaging obstacles such as trees and the like in use.

### SUMMARY OF THE INVENTION

To at least partially overcome some of these disadvantages of previously known devices, the present invention provides a novel construction for a vehicle body in which a support deck is disposed spaced below a rider support deck joined by tubular members in a rib cage-like manner.

To at least partially overcome some of these disadvantages of previously known devices, the present invention provides a reel mower gang with a frame structure encircling the reel mowers to protect the reel mowers from engaging obstacles. The reel mower gang also preferably supports each mower for effective pivoting as about a universal joint and with each reel mower independently determining its relative orientation.

In one aspect, the present invention provides a vehicle with a body comprising:

a lower deck extending along a longitudinal from a front end to a rear end and having left and right lateral sides,

an upper deck extending along a longitudinal from a front end to a rear end and having left and right lateral sides,

the upper deck is supported by a plurality of tubular rib members above the lower deck with the longitudinal of each aligned and with the upper deck spaced from the lower deck to define a cavity between the lower deck and the upper deck and within the rib members,

the rib members including left hand side ribs extending outwardly from the left hand side of the lower deck then upwardly and inwardly to the left hand side of the upper deck and right hand side ribs extending outwardly from the right hand side of the lower deck then upwardly and inwardly to the right hand side of the upper deck.

In another aspect, the present invention provides a reel mower gang assembly mountable to a vehicle to be moved forwardly by the vehicle to mow grass,

the assembly comprising an elongate boom having a first end and a second end,

the boom adapted to be mounted at a first end to the vehicle for pivoting about a generally horizontal first axis normal to a direction in which the vehicle is to move straightforwardly,

a reel type mower having two laterally spaced ground engaging wheels rotatable about a common wheel axis, the mower coupled to the second end of the boom for pivoting about a generally horizontal second axis normal to the first axis and for pivoting about a generally vertical third axis,

the vertical axis being substantially centered between the two wheels and forwardly of the wheel axis.

In another aspect, the present invention provides a reel mower gang assembly having a plurality of reel type mowers coupled together in an array, a guard rail assembly encircling the array spaced outwardly from the array and coupled to the arrays so as to provide a guide barrier preventing impact of the mowers of the array with obstacles to be encountered in mowing a lawn.

In one aspect, the present invention provides a novel construction for a body for a vehicle in which two elongate decks are provided supported in alignment one on top of the other and spaced from each other with rib members extending from each side of the decks outwardly to the side joining the sides of the decks and defining a cavity between the decks and inside the rib members. The ribs are preferably tubular members for strength but reduced weight. Each deck preferably forms an elongate beam. The upper deck preferably supports a seat for a rider for the vehicle. The lower deck preferably supports batteries to power the vehicle.

In another aspect, the present invention provides a reel mower unit adapted to be supported on a vehicle to move the unit. The reel mower unit includes a beam adapted to be coupled at a first end to the vehicle and adapted to be coupled at a second end to a reel mower of the unit. The boom is coupled at the vehicle at the first end and to the reel mower at a second end such that relative movement of the boom relative to the vehicle as by pivoting about a substantially horizontal axis which is normal to a direction in which the vehicle is to be driven permits the reel mower to be disposed at different heights relative the vehicle to engage the ground. The reel mower is preferably carried on the second end of the boom so as to also be pivotable about an axis parallel the axis about which the other end of the boom is pivotable relative the vehicle. In addition, the reel mower is preferably pivotable relative the second end of the boom about at least one of a generally vertical axis and an axis parallel to the direction in which the vehicle is to be moved. In accordance with the invention, a plurality of reel mower units may be provided with each mower unit carrying its reel mower and with the reel mowers arranged in an array to provide for cooperative cutting of the grass.

In another aspect, the present invention provides a reel mower gang comprising a plurality of reel mowers adapted to be moved via a vehicle over the ground to cut grass and, in which, a protected guard rail assembly is provided about the reel mowers so that a guard rail will come to engage obstacles which otherwise might be impacted by the reel mowers and damage the reel mowers. Such obstacles include tree trunks and the like. The guard rail assembly may preferably be provided forward of the reel mowers and/or laterally to the side of the reel mowers. The guard rail assembly may include portions which comprise sections of booms adapted to support a reel mower from a vehicle. The guard rail assembly could be independent of booms or other means which support a reel mower from the vehicle.

In accordance with the present invention, a reel mower gang is provided comprising a plurality of reel mower units each including a boom mounted at one end to a vehicle and carrying a reel mower to engage the ground at the other end. Each reel mower unit preferably is independently movable to permit the reel mower to assume different vertical positions relative to the vehicle. Preferably, at least one linking mechanisms couples two of the booms of individual reel mower units at a location away from the vehicle to reduce deflection of the individual beams yet permitting the individual reel mower units to be moved independently to different elevations relative the vehicle.

In another aspect, the present invention provides a mechanism for mounting a vehicle attachment, such as, a reel mower gang to a vehicle which mounting mechanism permits the attachment to assume different vertical positions relative the vehicle and which permits the attachment to be lifted to a raised position relative the vehicle. Preferably, the mechanism is supported so as to apply the weight of the attachment when raised on to the vehicle at a location intermediate a pair of wheel axles on which the vehicle rides on the ground.

In another aspect, the present invention provides a reel mower gang having a left hand reel mower unit and a right hand reel mower unit, each supported for assuming different vertical positions relative to the vehicle independently of each other and, in which, a separate mechanism is provided to raise each reel mower.

### BRIEF DESCRIPTION OF THE DRAWINGS

Further aspects and advantages of the present invention will become apparent from the following description taken together with the accompanying drawings in which:

FIG. 1 is a schematic pictorial view of a vehicle in accordance with a first embodiment of the present invention;

FIG. 2 is a schematic side view of the vehicle of FIG. 1;

FIG. 3 is a schematic plan view of the vehicle of FIG. 2 but with the vehicle in an orientation for turning;

FIG. 4 is a schematic pictorial view of a preferred embodiment of a reel mower gang in accordance with the present invention;

FIG. 5 is a schematic top view of the reel mower gang of FIG. 4 attached to a vehicle as shown in FIG. 1;

FIG. 6 is a schematic pictorial view showing a coupling arrangement for coupling a yoke bracket of a mower reel to the end of a boom;

FIG. 7 is a schematic front elevation view of the reel mower gang of FIG. 4 showing relative movement of the left and right boom;

FIG. 8 is a pictorial view of a reel mower;

FIGS. 9 and 10 are schematic side views of a support mechanism for supporting the reel mower gang secured to the lower deck and showing the same in a lowered and a raised position, respectively;

FIG. 11 is a schematic pictorial view of a vehicle in accordance with a second embodiment of the present invention;

FIG. 12 is a schematic left hand side view of the vehicle of FIG. 11;

FIG. 13 is a schematic front view of the vehicle of FIG. 11;

FIG. 14 is a schematic right hand side view of the vehicle of FIG. 11;

FIG. 15 is a plan view of the vehicle of FIG. 11;

FIG. 16 is a schematic rear view of the vehicle of FIG. 11;

FIG. 17 is a schematic top view of a reel mower gang attached to a vehicle similar to that shown in FIG. 5, however, with a second embodiment of a reel mower gang in accordance with the present invention; and

FIG. 18 shows a schematic top view of a reel mower gang attached to a vehicle similar to that shown in FIG. 5, however, with a third embodiment of a reel mower gang in accordance with the present invention.

### DETAILED DESCRIPTION OF THE DRAWINGS

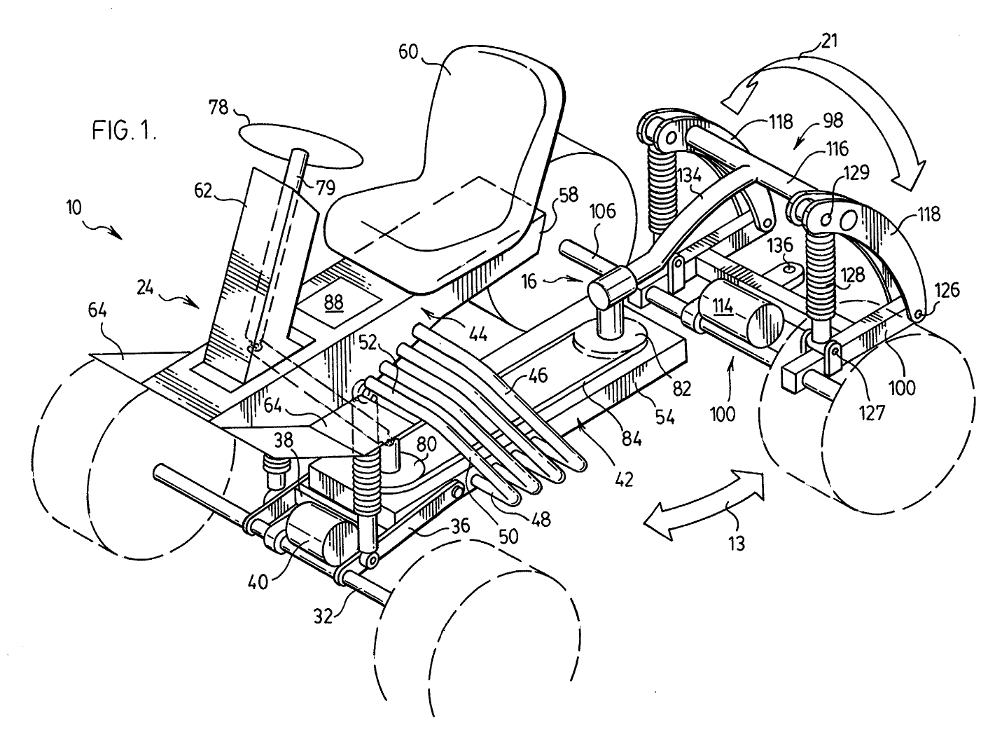

Reference is made to FIGS. 1, 2 and 3 which show a preferred embodiment of a vehicle 10 in accordance with the present invention. Vehicle 10 has a front vehicle segment 12 and a rear vehicle segment 14 coupled together by a crab coupling 16. The front segment 12 is disposed about a generally horizontal front longitudinal axis 18 and the rear segment 14 is disposed about a generally horizontal rear longitudinal axis 20. The crab coupling 16 permits relative rotation of the front segment 12 and the rear segment 14 about the rear horizontal axis 20 and about a first generally vertical crab axis 22 roughly normal to both the axis 18 and the axis 20. By changing the relative angulation of the front segment 12 and the rear segment 14 as about the arrow indicated 13 in FIG. 1, the vehicle can be steered in a crab-like manner.

The front vehicle segment 12 includes a front body 24 carried on a front carriage 26 and suspended therefrom by a front suspension mechanism.

The front carriage 26 includes a pair of front wheels 30 carried on a front axle 32 journalled to a rigid H-shaped front carriage frame 34. The front carriage frame 34 has two longitudinal frame members 36 joined by transverse frame member 38. A front electric motor 40 is mounted to the frame 34 between members 36 and coupled by a gearing arrangement to the front axle 32 to rotate the front axle 32.

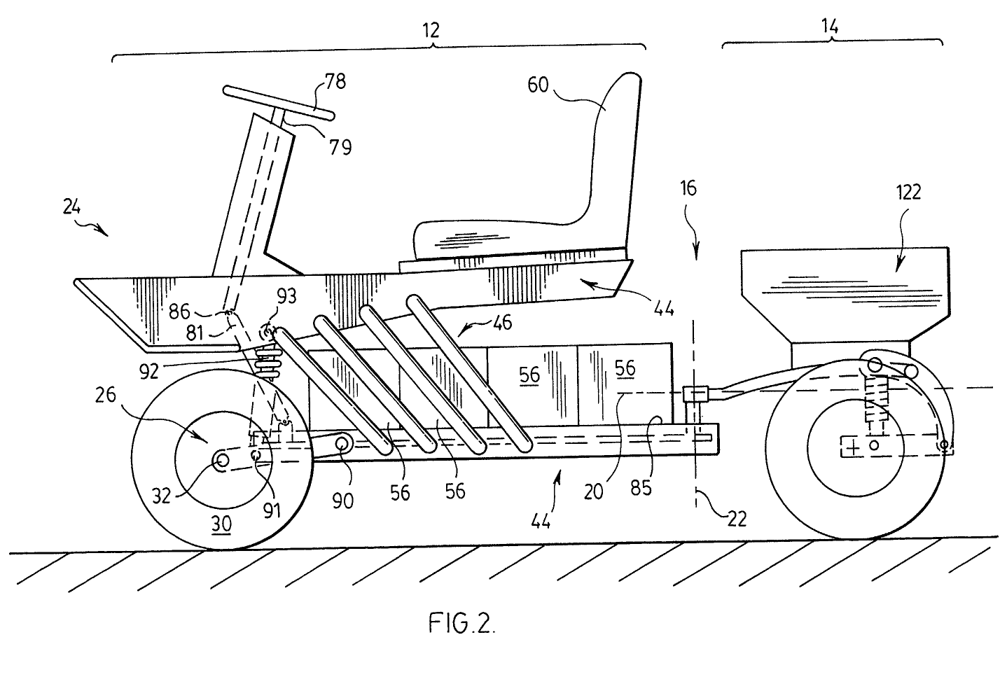

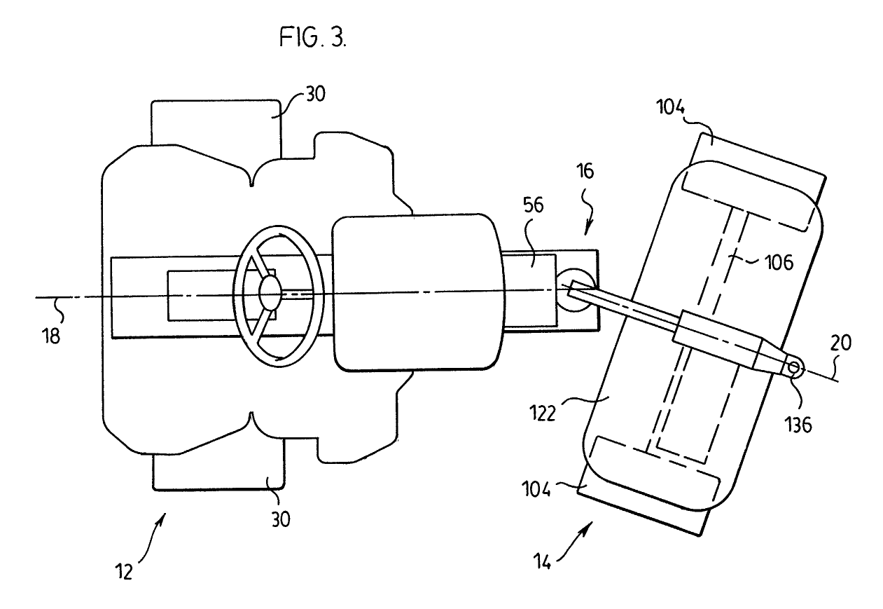

The front body 24 has a rigid framework formed from an elongate longitudinally extending lower deck 42 and an elongate longitudinally extending upper deck 44 spaced above the lower deck 42 and coupled together by a plurality of longitudinally spaced tubular rib members 46. Each rib member 46 extends laterally outwardly from the lower deck 42 as a lower arm portion 48, then upwardly as a rib side portion 50, then laterally inwardly to the upper deck 44 as an upper arm portion 52. The lower arm portion 48 and the upper arm portion 52 are disposed generally horizontally. The side rib portion 50 angles forwardly and upwardly disposed in a generally vertical plane parallel the front longitudinal axis 18. The rib members 46 are spaced longitudinally from each other and provide an enlarged open cavity inside the rib members 48 and between the lower deck 42 and the upper deck 44 as in the manner of an animal's rib cage. The open structure formed between the upper and lower decks and the rib members provide ease of access to an array of four batteries 56 carried on the lower deck 42 as seen in FIGS. 2 and 3. The batteries 56 may be covered by a removable shroud (not shown) as may be made from a flexible mesh or canvas cloth or the like.

The lower deck 44 has a pair of longitudinally extending beam members 54, one extending along each side of the lower deck spaced a width so that the deck 44 can receive and support the plurality of batteries 56 thereon. Preferably, the lower deck 44 has a lateral width from side-to-side which is only marginally greater than the length of a conventional rectangular automotive battery.

The upper deck 44 has a series of longitudinally extending beam members 58 which support, amongst other things, the user seat 60, a steering wheel support tower 62 and foot support plates 64. The upper deck 44 slopes upwardly and rearwardly. The seat 60 is slidable along mounting rails on the upper deck parallel the upper deck with a seat adjustment mechanism to lock and release the seat at different locations as desired. With the upper deck 44 sloped upwardly and rearwardly, sliding of the seat on its mounting rails parallel the deck rearwardly also increases the height of the seat.

The steering wheel support tower 62 rises upwardly from the upper deck 44 forward of the seat 60 and carries the steering wheel 78. The steering wheel 78 is mounted on a steering axle 79 which extends downwardly and is coupled by a line rod 81 to a front steering chain sprocket 80 journalled to the lower deck 42 for rotation about a generally vertical axis. The front steering chain sprocket 80 is forward of the batteries 56. A rear steering chain sprocket 82 is carried on the crab coupling 16 journalled on the lower deck 42 for rotation about the vertical crab axis 22. The rear steering chain sprocket 82 is located on the lower deck 42 rearward of the batteries 56. The lower deck 42 carries two longitudinally extending raceways which permit a steering chain 84 which engages about the sprockets 80 and 82 to pass between the sprockets underneath the batteries 56. In this regard, each of the raceways 85 are provided proximate the sides of the lower deck 42. The lower deck 42 has a battery support platform 85 provided at a height above the raceways.

Rotation of the steering wheel 78 rotates the front chain sprocket 80 which rotates the rear chain sprocket 82, thereby rotating the crab coupling 16 and thereby the rear vehicle segment 14 relative the front vehicle segment 12.

The steering wheel support tower 62 is pivotally mounted to the upper deck 42 for pivoting about a tilt axis schematically indicated as 86. A releasable latch mechanism (not shown) permits locking of the tower 62 into desired positions.

A display panel 88 is provided on the upper deck 44 between the seat 60 and the tower 62 for display of information relative the operation of the vehicle. The display panel 88 is preferably protected by a metal screen. The space under the display panel 88 houses an electronic control mechanism for the vehicle.

A three-point front suspension system supports the forward end of the front body 24 on the front carriage 26. In this regard, the rear end of the longitudinal frame members 26 are pinned to the lower deck 44 at each side with coaxially disposed suspension pins 90 extending parallel to the front axle 32 spaced rearwardly thereof to permit relative pivoting of the front body 24 relative the front carriage 26. A conventional axially extending resilient strut assembly 92 has a lower end 91 journalled by pinning to the front carriage 26 rear of the front axle 32 for pivoting parallel the axle 32 and an upper end 93 journalled by pinning to the upper deck 44 of the front body for pivoting parallel the axle 32. The upper end 93 of the strut assembly 92 is above and to the rear of the axle 32. The strut assembly 92 includes an axially telescoping shock absorber with a helical spring coaxially coupled thereabout. With increased forces acting downwardly on the front body 24, the strut assembly 92 compresses pivoting the front body 24 relative the front carriage 26 about suspension pivot pin 90.

The rear vehicle segment 14 includes a rear body 98 carried on a rear carriage 100 suspended thereon by a suspension system. The rear carriage 100 includes a pair of rear wheels 104 carried on a rear axle 106 journalled to a rigid rear H-shaped carriage frame. The rear carriage frame has two longitudinal frame members 110 joined by a transverse frame member 112. A rear electric motor 114 is mounted to the rear carriage frame between members 110 and coupled by a gearing arrangement to the rear axle 106 to rotate the rear axle. The rear body 98 has a rigid framework including a cross beam 116 parallel to rear axle 106, two rear support arms 118 which support a rear platform 122 only shown in FIGS. 2 and 3.

A three-point rear suspension system supports the rear body 98 on the rear carriage 100. In this regard, the rear end of the longitudinal frame members 110 are pinned to the lower rear end of the support arms 118 on each side with coaxially disposed suspension pivot pins 126 extending parallel to the rear axle 106 spaced rearwardly thereof to permit relative pivoting of the rear body 98 relative the rear carriage 100. As with the front vehicle segment 12, a conventional axially extendable resilient strut 128 is provided which comprises a shock absorber with a helical spring coaxially coupled thereto. Strut 128 has a lower end 127 journalled by pinning for pivoting parallel the axle 106 to the longitudinal frame member 110 of the rear carriage 100 rearward of the axle 106 and an upper end 129 journalled by pinning for pivoting parallel the axle 106 to the rear body 98 above the axle 106. With increased forces acting downward on the rear body 98, the strut assembly 92 compresses pivoting the rear body 98 relative the rear carriage 100 about suspension pivot pin 126.

The rear body has a tongue member 134 which extends forwardly from fixed connection with the center of the cross beam 116 and is coupled at its forward end to the crab coupling 16, journalled to the crab coupling 16 for rotation about the rear longitudinal axis 20. Providing the crab coupling 16 to permit relative pivoting between the front vehicle segment 12 and the rear vehicle segment 14 about the rear longitudinal axis 20 as about the arrow indicated 21 assists the vehicle in moving over uneven terrain such that, in effect, the front axle 32 and the rear axle 106 can assume different angulations relative to a horizontal.

With the front body 24 suspended on the front carriage 26 and the rear body 98 suspended on the rear carriage 100, the combined vehicle body comprising the front body 24, the crab coupling 16 and the rear body 98 is, as a unit, supported fully suspended on the four wheels via the front carriage 26 and the rear carriage 100 so as to provide a comfortable ride for a user.

A trailer hitch 136 is coupled to the transverse frame member 112 of the rear carriage frame 108 centrally thereof.

The vehicle 10 has a control system which provides for simultaneous operation of the front electric motor 40 and the rear electric motor 114 to provide for all wheel drive to the vehicle.

An accessory coupling and lift mechanism can be provided on the front end of the vehicle 10 for securing attachments to be pushed by the vehicle 10. Useful attachments include but are not limited to reel mower gangs, deck mowers, snow blades, snow blowers, tillers and plows. The attachments are preferably mounted such that they are coupled to the suspended front body 24 and the attachments may be lifted to be carried supported on the front body 24 and the vehicle's suspension systems. Appropriate power takeoff may be provided where necessary to power the attachments as, for example, to provide power to grass cutting blades of deck mowers and to motors of snow blowers and the like.

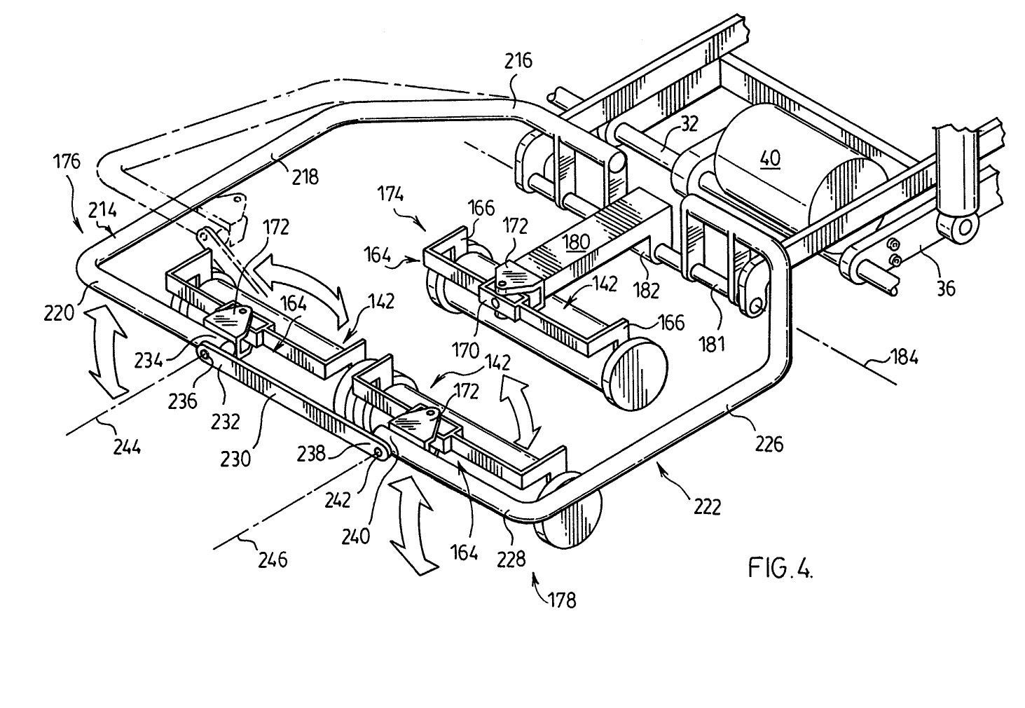

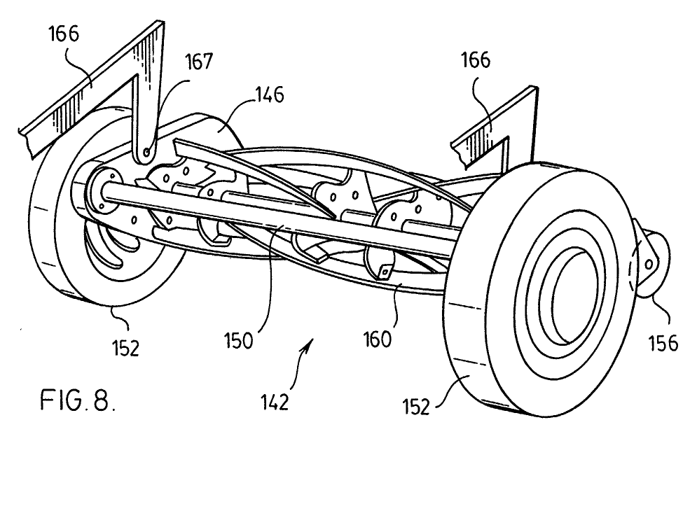

Reference is made to FIGS. 4 to 7 which illustrate a preferred reel mower gang 140 in accordance with a preferred embodiment of the present invention. In the FIGS. 4 to 7, each reel mower 142 has a construction which is schematically shown. Reel mowers are well known. One known reel mower 142 is shown in FIG. 8 as having a rigid framework comprising two spaced end plates 146 secured together in spaced relation notably by a spacer tube and cutter bar 150. Two ground engaging drive wheels 152 are journalled on the end plates 146 for rotation about a common wheel axis. A ground engaging roller 156 is located between the end plates 146 for rotation on a roller axis parallel the wheel axis 154 and rearwardly thereof. A reel 160 is located between the end plates 146 journalled for rotation about a reel axle 162 parallel the wheel axis. Each end of the reel is journalled to the end plates 146. The reel 160 is coupled via a one-way pinion gear to gearing teeth inside the hub of the driving wheels 152 such that rotation of the wheel 152 in a forward direction rotates reel 160, however, when the wheel 152 is rotated in the other direction, the reel 160 is free to continue to rotate in a forward direction. The reel 160 carries helical cutting blades which pass sufficiently close to a fixed, but adjustable, cutter bar 150 to cut grass caught therebetween. Two spaced bracket arms 166 are pinned at 167 to the end frames 146 to draw the mower forwardly to the right as seen in FIG. 8 to cut grass.

Referring again to FIGS. 4 to 7, each mower 142 is adapted to be drawn forwardly by a yoke bracket 164 having two spaced bracket arms 166 which are pinned at their rear end 168 to the respective end plate 146 of the reel mower 142. The yoke bracket 164 has a central portion 170 which is coupled to a yoke coupling 172 carried on a boom for the respective mower 142.

The reel mower gang 140 includes three mower units, namely a rear center mower unit 174, a front right mower unit 176 and a front left mower 178. Each of the three mower units includes its respective reel mower each indicated as 142, yoke bracket, each indicated as 164 and a support boom. The center mower unit 174 has a center reel mower 142 adapted to be drawn forwardly by its yoke bracket 164 coupled via yoke coupling 172 to the center boom 180. The center boom 180 is pivotally mounted at its rear end 182 to the lower deck 42 of the vehicle 10 for pivoting about a boom pivot pin 181 having generally horizontal boom axis 184 generally parallel to the front wheel axis 32.

The yoke coupling 172 includes an upper plate 192 and a lower plate 194 spaced apart from each other and secured to the front end 186 of the center boom 180 so as to provide a space 186 between the two plates. An axle 198 extends between the plates 192 and 194 normal thereto and journalled in openings in the plates 192 and 194 by suitable bearings for pivoting relative the plates about a central axis 200 of the axle 198. The center portion 170 of the yoke bracket 164 has two spaced parallel bars 188. The bars 188 extend through the space 196 between the plates 192 and 194 with the pivot axle 198 disposed in between the bars 188. The bars 188 are coupled to the axle 198 by a pivot bolt 210 which extends through each bar 188 normal to the bars and normal to the axle axis 200 such that the bars 188 are journalled for pivoting relative the axle 198 about bolt axis 212 normal the axle axis 200.

The yoke coupling 172 thus couples the yoke bracket 164 to the front end 186 of the center boom 180 for pivoting about the axle axis 200 and the bolt axis 212 which are generally normal to each other and generally normal to the boom axis 184.

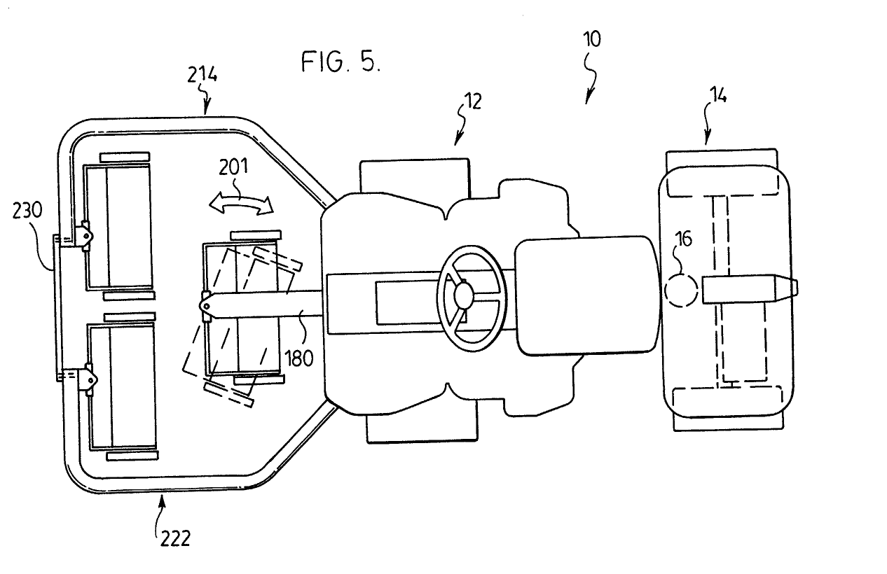

In this manner, the center reel mower 142 of the center mower unit 174 is carried by the vehicle 10 for movement in a universal joint type manner. As seen in FIG. 5, the axle axis 200 is forward of the axle about which the wheels 152 rotate and centered between the wheels 152. This assists in ensuring that the reel mower 142 follows the axle axis 200 in a castering manner that is with the drag of the wheels on the ground tending to orientate the reel mower to orientate its wheels to be parallel to a direction in which the axle 198 is moved.

The relative pivoting about each of the axle axis 200 and the bolt axis 212 are limited to constrain movement of the reel mower 142.

Relative pivoting of the yoke bracket 164 about the bolt axis 212 is limited by engagement of the bars 188 of the central portion 170 of the yoke bracket 164 with the periphery of the upper and lower plates 192 and 194. Relative pivoting about the pivot axle 198 is limited by engagement of the central portion 170 of the yoke bracket 164 with the front end 186 of the center boom 180 between the upper and lower plates 192 and 194. The relative pivoting about the bolt axis 212 and about the axle axis 200 are interdependent and will depend upon the relative positions of each other. The relative pivoting about the pivot axis 200 and about the bolt axis 212 may be predetermined, for example, by the relative shape, size and locations of the bars 188, axle 198, plates 192 and 194 and the front end 186 of the center boom 180.

Preferably, pivoting of the yoke bracket 164 about the bolt axis 212 is through an arc of about 60°. Preferably, pivoting of the yoke bracket 164 about the axle axis 200 is up to about 120°.

The center boom 180 is pivotally mounted to the vehicle 10 for pivoting about the boom axis 184. In use to cut grass, the reel mower 142 rides on the ground carrying the weight of the center mower unit 174. The center mower unit 174 is free to pivot about the boom axis 184 to accommodate different elevations of ground relative that experienced by the vehicle 10. The boom axis 184 permits pivoting of the center boom 180 both upwardly and downwardly. With the reel mower 142 engaged on the ground, the reel mower may pivot about the bolt axis 212 such that the wheel axis 154 of the reel mower 142 may assume a different angulation compared to that of the front axle 32 of the vehicle 10. With the yoke coupling 172 to pivot about the axle axis 200 as indicated by the arrow 201 in FIG. 5, the reel mower 142 can assume a configuration as, for example, with one of its wheels 152 to be located farther ahead than the other of its wheels 152 as can be advantageous as, for example, when the vehicle 10 may be moved forwardly turning in an arc which would be centered on the vehicle body intermediate the front wheels 30 and the rear wheels 104.

Thus, in use, to be understood that the reel mower 142 is free to adopt its relative orientation on the ground as dictated by pivoting of the center boom 180 about the boom axis 184 and as dictated by the relative pivoting of the yoke coupling 172 about the axle axis 200 and the bolt axis 212.

The right mower unit 176 includes a right beam 214. The right boom 214 has a rear arm portion 216, a side arm portion 218 and a front arm portion 220. The rear arm portion 216 and the front arm portion 220 extend laterally to the side generally transverse to the front longitudinal axis 18. The side arm portion 218 extends forwardly generally parallel to the front longitudinal axis 18. Each of the rear arm portion 216, side arm portion 218 and front arm portion 220 lie in a common plane. The rear arm portion 216 is pivotally mounted to the lower deck 42 of the vehicle 10 for pivoting about the boom axis 184. The right reel mower 142 is mounted to the front arm portion 220 by a yoke coupling 172 and yoke bracket 164 substantially the same as that described with the center mower unit 174, however, with the upper plate 192 and the lower plate 194 extending rearwardly of the front arm 220 of the right boom 214 rather than forwardly of the front end 186 of the center boom 180.

The left mower unit 178 includes a left boom 222 which is a mirror image of the right boom 214 and similarly has a rear arm portion 224, side arm portion 226 and front arm portion 228 with the rear arm portion 224 pivotally mounted to the lower deck 42 of the vehicle for pivoting about the boom axis 184. The left mower 142 is mounted to the front arm portion 228 by a yoke coupling 172 and yoke bracket 164 which mirror those of the right mower unit 176.

A boom linking rod 230 has a right end 232 pinned to the front inner end 234 of the right boom 214 via a right pin 236 for relative pivoting about an axis 244 of the right pin 232. The boom linking rod 230 has a left end 238 pinned to front inner end 240 of the left boom 222 via a left pin 242 for relative pivoting about an axis 246 of the left pin 242.

The axes 244 and 246 of the right and left pins are parallel to each other and substantially normal to the boom axis 184 and, as well, each lies in a plane in which the respective right or left boom lies.

The boom linking rod 230 joins the front inner ends 234 and 240 of the right boom 214 and the left boom 222 such that the right boom 214, left boom 222 and boom linking arm 230 form a guard rail assembly which is located outwardly of the three mowers 142 about the lateral sides and front thereof. The individual mowers 142 and particularly the front right and front left mowers 142 are restricted to movement relative the guard rail assembly and particularly the individual respective left and right booms 214 and 222 so as, in normal use in mowing grass, to maintain positions substantially inside the outer perimeter of the guard rail assembly. The guard rail assembly thus provides a protective physical guard to the mowers 142. Obstacles such as tree trunks, fence posts and the like which rise up to the height of the guard rail assembly may be engaged by the guard rail assembly protecting direct engagement with the mowers 142 and, therefore, protecting the mowers against damage.

The boom linking rod 230 permits the right boom 214 and the left boom 222 to pivot about the boom axis 184 independently of each other as illustrated in FIG. 7. The boom linking rod 230 in joining the right boom 214 and the left boom 222 forms the guard rail assembly as a substantially closed loop which provides increased strength to the guard rail assembly and reduces the tendency of either of the right boom 214 or the left boom 222 to deflect unduly laterally side-to-side. The boom linking rod 230 increases the overall strength of the guard rail assembly and permits the individual right and left booms to be made from lower weight, lower strength tubular members.

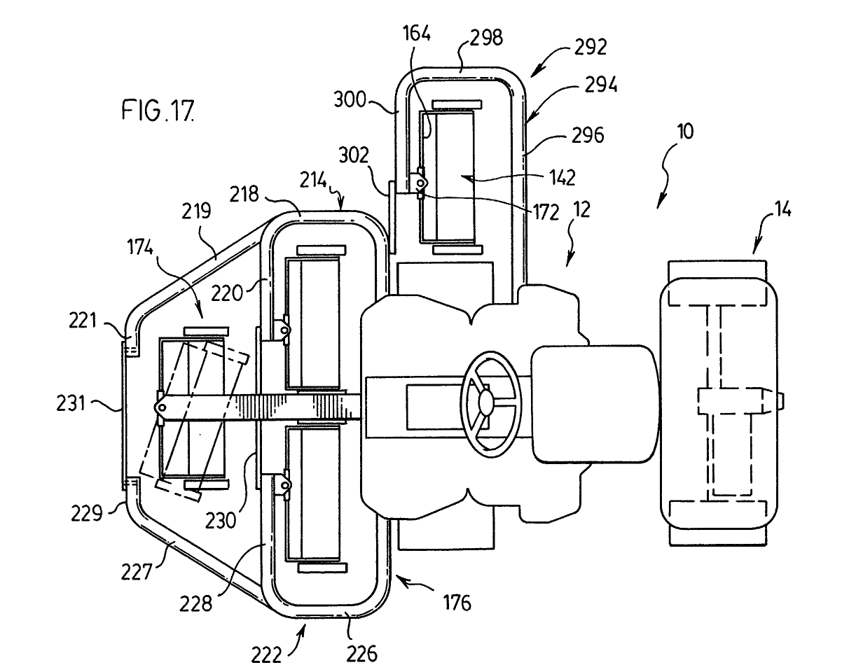

Reference is made to FIG. 17 which shows a second embodiment of a reel mower gang in accordance with the present invention. Like the first embodiment illustrated in FIG. 5, the second embodiment incorporates three reel mowers 142 forward of the vehicle. In a second embodiment, the reel mower gang also includes three mower units. In FIG. 17, similar reference numerals are used to refer to equivalent elements in the first and second embodiments of the mower gangs. A principal difference between the embodiment of FIG. 5 and the embodiment of FIG. 17 is that in FIG. 17, the center mower unit 174 is forward of the right mower unit 176 and the left mower unit 178. This is accomplished by the center boom 180 being of increased length and arcing upwardly over the left and right mower units 176 and 178 and then downwardly. Each of the right mower unit 176 and left mower unit 178 are substantially functionally identical, however, with their side arm portions 218 and 226 of reduced length to locate the front arm portion 220 of the right boom 214 and the front arm portion 228 of the left boom 222 closer to the front end of the vehicle and rearward of the reel mower 142 of the center mower unit 174.

In addition, the right boom 214 includes a side arm extension portion 219 and a secondary front arm portion 221 both fixedly secured thereto. Similarly, the left boom 222 includes a side arm extension portion 227 and a secondary front arm portion 229. The secondary front arm portions 221 and 229 are connected by a secondary boom linking arm 231 in a substantially identical manner to the boom linking rod 230. The boom linking rod 230 is unnecessary in the embodiment of FIG. 17 and could be avoided merely by having the boom linking rod 231.

In the embodiment of FIG. 17, the right boom 214, the left boom 222 and the boom linking arm 231 continue to form a guard rail assembly within which each of the mowers 142 is received with sufficient room for each of the mowers 142 to pivot and tilt in desired manners. Having the left and right mower units 176 and 178 closer to the vehicle is advantageous so as to reduce the forces required to lift their booms to a raised position.

Insofar as there may be concerns that secondary forward arm portions 229 or 221 of the left and right booms may engage with the ground, it would be possible to place a simple castering wheel on each of these front arm portions 221 and 229 or, alternatively, the boom linking rod 231 could be coupled at its center to the forward end of the boom 180 as in a manner, for example, for pivoting about an axis parallel the pins at each end of the boom linking rod 231.

The embodiments illustrated in FIGS. 5 and 17 each show three mower units forward of the vehicle. It is within the scope of the present invention to have any reasonable number of mower units. For example, additional booms could be provided which extend laterally from the vehicle 10 and could similarly mount reel mower units, for example, to one side of the vehicle. In this regard, one such wing mower unit is shown on the right hand side of the vehicle 10 in FIG. 17 as wing mower unit 292 having its boom 294 with a rear arm portion 296 which extends laterally and is coupled to the vehicle for pivoting about a horizontal axis parallel the axle 32 of the front wheels of the vehicle. As with the other mower units, the wing mower boom 294 has a side arm portion 298 and a front arm portion 300 and carries a reel mower 142 on a yoke bracket 164 and yoke coupling 172. In FIG. 17, there is shown a wing boom linking rod 302 which links the end of the wing boom 294 to the right side boom 214 pinned at each end for relative pivoting about pins at its end in a similar manner to the boom linking rod 230.

The wing boom linking rod 302 is not necessary but can provide some stability.

Preferably, in the embodiment shown in FIG. 17, the reel mower 142 of the right mower unit 176 would extend laterally sufficiently that its cut would overlap with the cut of the reel mower 142 of the wing mower unit 292.

To raise the wing mower unit, its rear arm portion 296 of its boom 294 could also be provided to pivot upwardly about an axis parallel the longitudinal axis 18 of the front vehicle segment 12.

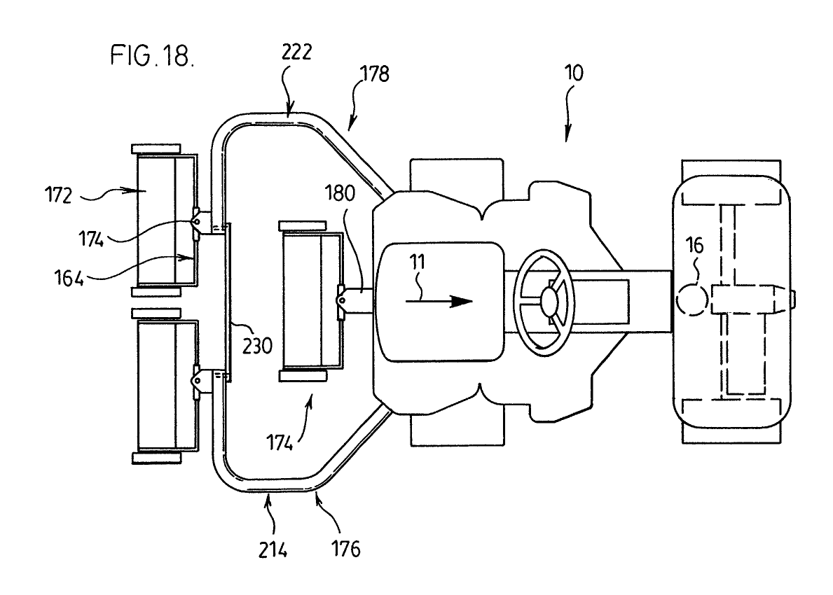

The preferred embodiments illustrated notably in FIGS. 5 and 17 are particularly adapted to be pushed forwardly via a vehicle. A gang boom assembly in accordance with the present invention can be adapted to be towed behind the vehicle. Such an embodiment is illustrated in FIG. 18 which shows a vehicle 10 similar to that in the embodiment of FIG. 1, however, in which the seat and steering wheel have been reversed, therefore, with the vehicle adapted to be driven forwardly to the right as indicated by arrow 11.

The reel mower gang continues to include three mower units, namely, a center mower unit 174, a right mower unit 176 and a left mower unit 178. All of the parts are effectively equivalent to that shown in the embodiment illustrated, for example, in FIG. 5, however, each yoke coupling 172 extend rearwardly from the respective center boom 180, right boom 214 and left boom 222. The same lift mechanism could be used with the embodiment of FIG. 18 as is utilized with the embodiment of FIG. 5.

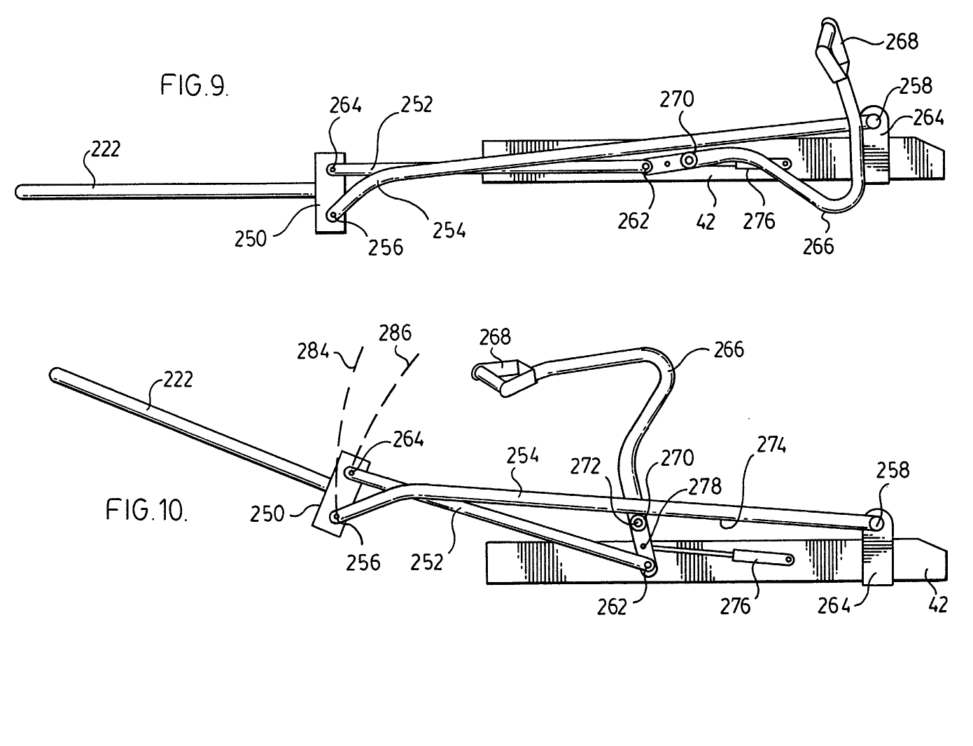

Reference is made to FIGS. 9 and 10 which schematically illustrate a support mechanism for supporting the reel mower gang. In FIGS. 9 and 10, the reel mower gang is only schematically illustrated as being represented by the left boom 222 which is shown to have a boom lift bracket 250 fixedly secured at its rear. The boom lift bracket 250 is coupled to the lower deck 42 by a short support lever 252 and a long support lever 254. The long support lever 254 is pinned at its front end to the boom lift bracket 250 for pivoting about pin 256 and is pinned at its rear to a post 264 fixed to the lower deck for pivoting about pin 258. The short support lever 252 is pinned at its rear end to the lower deck 42 at pin 262 and is pinned at its front end to the boom lift bracket 250 for pivoting about pin 264.

A lift lever 266 is pinned at its lower end by pin 262 to the lower deck 42. The lift lever has a handle 268 at its upper end to be grasped by a hand of a person sitting on the vehicle. The lift lever 266 carries a lift roller 270 journalled thereon about a pin 272. The lift roller 270 engages the undersurface 274 of the long support lever 254. A lift cylinder 276 is pinned via a pin 278 to the lift lever 266 and via a pin 280 to the lower deck 42. The lift cylinder is preferably a gas strut or other mechanism which biases its ends and therefore the pins 278 and pins 280 apart.

FIG. 9 shows the support mechanism with the boom 222 in a lowered position ready to mow grass with the reel mower 142 engaging the ground. To maintain engagement with the ground, the entire assembly of the boom 222 and levers 252 and 254 can pivot further downward as far as the lift lever 266 may permit. The boom 222 can also pivot upwardly since the short support lever 252 and the long support lever 254 are not restrained from pivoting upwardly about their rear ends.

FIG. 10 shows the support mechanism with the boom 222 in a raised position. To move from the lowered position of FIG. 9 to the raised position of FIG. 10, a user moves the lift lever 266 such that the lift roller 270 forces the long support lever 254 upwardly, pivoting the long support lever 254 about its rear pin 258 with the result of moving the boom 222 and the short support lever 252. The gas lift cylinder 276 assists in lifting the weight of the broom 222 by applying forces which urge its ends and, therefore, pins 278 and 280 apart, biasing the lift lever 266 towards the raised position.

The combination lever linking arrangement comprising the short support lever 252, the long support lever 254, the lower deck 42 and the boom lift bracket 250 are selected such that on raising the boom, the center of mass of the boom is moved farther rearwardly for a given angle of movement of either the short support lever 252 or the long support lever 254 as compared to having the boom pivotable as a single rigid lever pinned to either the pin 262 or the pin 258, respectively. The pin 256 on the forward end of the long support lever 254 moves through the arc 284 of the longer support lever 254. The pin 264 on the forward end of the short support lever 252 moves through the arc 286 of the short support lever 252. As the arcs 284 and 286 diverge upwardly, as the boom lift bracket 250 moves upwardly, it must assume an orientation which increasingly moves the boom 222 towards a vertical position and moves the junction of the boom 222 with the boom lift bracket 250 rearwardly relative the lower deck 42. Having a center of mass of the boom move rearwardly relative the lower deck 42 is advantageous to reduce the moment of the mass of the boom 222 tending to pivot the vehicle 10 about the front axle 32 and to place the weight of the boom 222 when raised to act as far as possible rearward relative the front axle 32 and preferably between the front axle 32 and the rear axle 106, so that the suspension of the vehicle can advantageously carry the weight of the raised boom.

To accommodate coupling and uncoupling of the reel mower gang, each of the pins which engage the boom lift bracket 250, namely, the pins 256 and the pins 264 can be releasable pins. For example, they can be releasable pins which have removable cotter pins at either ends and which pins can be manually removed by removing the cotter pins so as to disengage the boom lift bracket and, therefore, the entire reel mower gang from engagement with the vehicle 10.

In the vehicle as shown, the support mechanism for supporting and raising the reel mower gang is provided on each side of the vehicle. The lift levers 266 can be operated independently so that effectively each half of the reel mower gang may be raised independently thus reducing the lifting forces which need to be applied by a user at any given time.

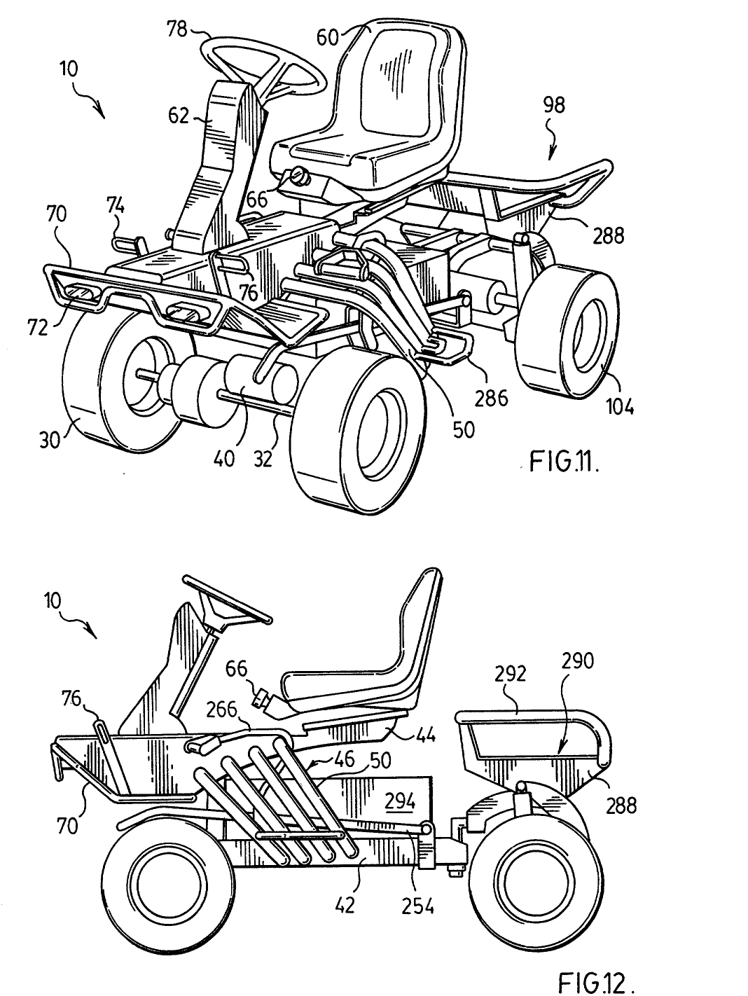

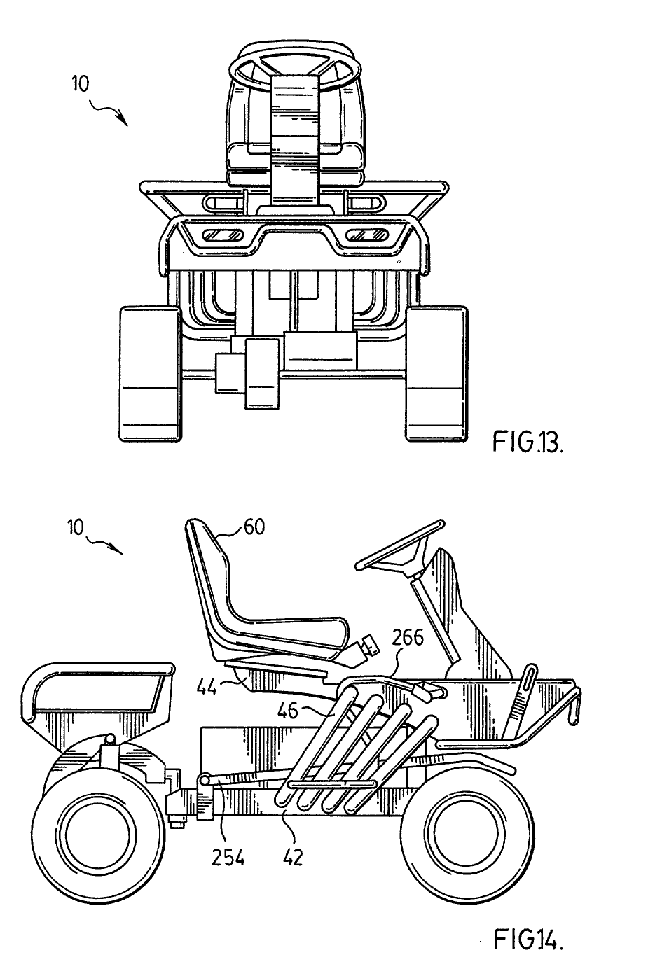

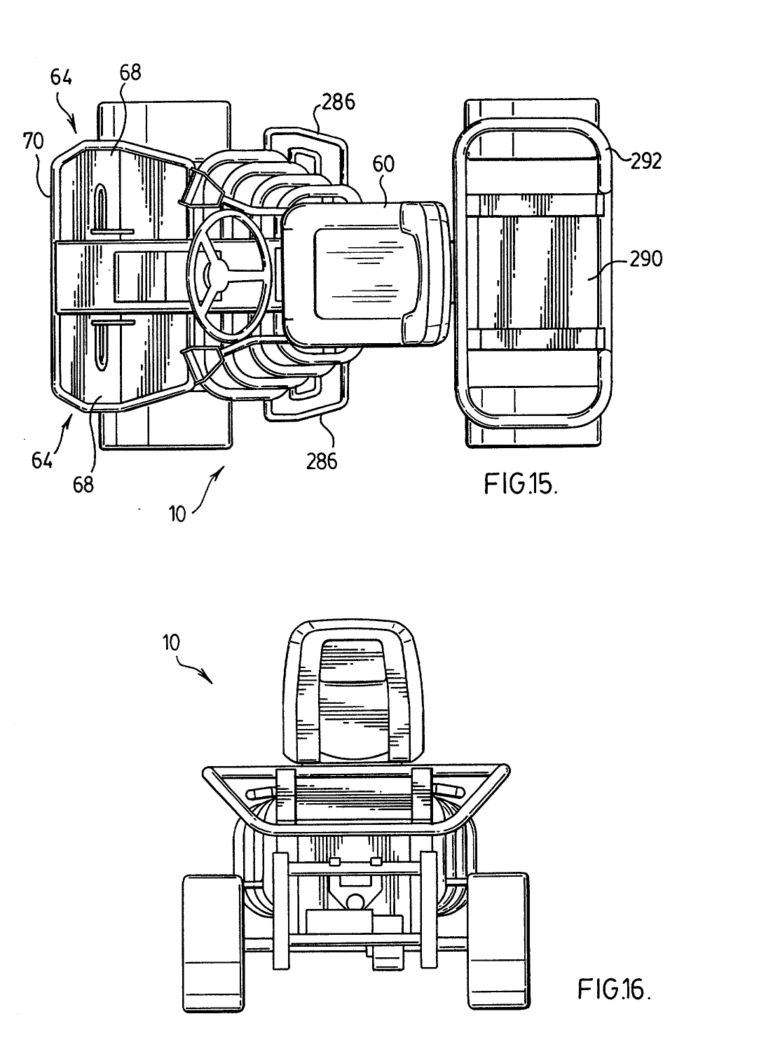

Reference is made to FIGS. 11 to 16 which schematically illustrate a second embodiment of a vehicle 10 in accordance with the present invention and in which various elements are not shown to facilitate illustration of certain features. FIGS. 11 to 16 particularly illustrate a preferred arrangement and visual arrangement of the front body 24 with its lower deck 42, upper deck 44 and rib members 46. The rib members are clearly shown to include left and right side ribs each of which extend outwardly from the lateral side edges of the lower deck 42, then upwardly and inwardly to the lateral side edges of the upper deck 44. The left and right side members of each rib member 46 preferably are a continuous tubular member which extend from the left hand lateral side of the lower deck 44 upwardly and then through the upper deck 44 to the right hand lateral side of the lower deck 42 as to provide enhanced rigidity.

A horizontal, laterally extending step 286 is shown secured to the rib side portions 50 on each side. The step 286 can assist a user to mount the vehicle 10.

A safety kill button 66 is carried on the seat at its lower front to be positioned between a user's legs. When pressed by a user, the kill button 66 stops all power transfer from the batteries to the motors.

Foot support plates 64 are provided at each side of the upper deck 44 and comprise metal mesh sheeting 68 supported at its perimeter by a tubular frame member 70 welded at its ends and center to the upper deck 44. The tubular frame member 70 also supports headlights 72. Foot pedals 74 and 76 are coupled to the upper deck 44 and extend upwardly from below the foot support plate 64 for manipulation by a user's foot. The right foot pedal 74 is an accelerator pedal and adapted for reverse by drawing the pedal forwardly from a neutral position. The left foot pedal 76 is a brake pedal.

The rear body 98 is shown to include longitudinally extending beams 88 to support a rear platform 290 with a safety rail 292 secured therearound.

A battery shroud 294 is shown to cover batteries carried on the lower deck 44.

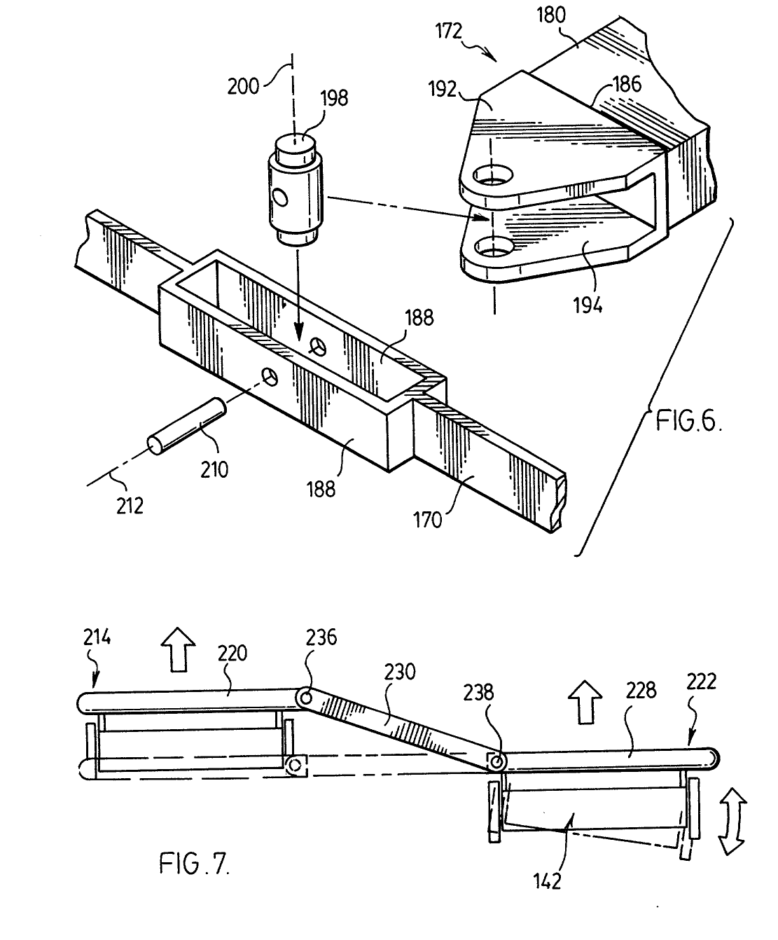

FIGS. 11 to 16 show, in a raised position, the lift lever 266 and the long support lever 254 of the support mechanism illustrated in FIGS. 9 to 10. FIGS. 6 to 11, for simplicity, do not show other elements of the support mechanism. It will be noted that FIGS. 11 to 16 do not show all the elements of the front or rear carriages or the suspension systems.

Each reel mower 42 is pinned to the bracket arms 166 of the yoke bracket 164 via pins 167 in a manner that pivoting of the reel mower 142 relative the bracket arms 166 is provided about an axis parallel the axis about which the drive wheels 152 rotate and in a manner that the driving wheels 152 and the roller 156 engage on the ground so as to orientate the reel mower 142 in the position relative the ground suitable to cut grass. Each mower unit which includes the reel mower 142, yoke bracket 164 and its support boom is mounted to the vehicle for pivoting about a generally horizontal boom axis 184 parallel to the front wheel axis 32 of the vehicle. Pivoting about a horizontal boom axis, for example, the boom axis 184 for the center mower unit 174 effectively accommodates the location of the reel mower 142 at different heights relative the vehicle 10. Such height adjustment capability arises when the horizontal boom axis is spaced from the axis about which the reel mower 142 is pinned to the bracket arms 166, preferably with the horizontal boom axis spaced either forwardly or rearwardly from the reel mower 142 in respect of the normal direction in which the vehicle 10 is to be driven.

The preferred embodiments show that in each mower unit, in addition to the reel mower 142 being movable vertically by pivoting about the generally horizontal boom axis 184 and the reel mower being pivotable relative the bracket arms 166 about an axis parallel the axis about which the drive wheels rotate, the reel mower 142 may also pivot about the axle axis 200 and the bolt axis 212. It is not necessary that the reel mower 142 be capable of pivoting about the axle axis 200 or the bolt axis 212 or both. In accordance with the present invention, advantageous arrangements would arise with the reel mower 142 secured to each bracket arm so as to have the axis about which its drive wheels rotate maintained parallel the generally horizontal boom axis. Pivoting may be provided about merely one of the axle axis 200 or the bolt axis 212 and while this is preferred, it is not necessary.

Pivoting about the axle axis 200 is particularly advantageous for a reel mower 142 which is disposed with increasing distance from a steering center about which the vehicle 10 turns. Therefore, it is advantageous to have reel mower 142 farthest forward from a vehicle pivotable about its axle axis 200 yet other reel mower 142 closer to the vehicle may not be adapted to pivot about such an axle axis 200. In the context of the embodiment shown in FIG. 17, for example, it may be unnecessary to have the wing mower unit 292 adapted for pivoting about the axle axis 200. Similarly, in the context of FIG. 17, the reel mower of each of the right and left mower unit which are located close to the vehicle may not be substantially disadvantaged by being constrained so that they do not pivot about their axle axis 200.

In the illustrated embodiments, each mower unit is shown as comprising merely one reel mower 142. It is to be appreciated that for any one boom, more than one reel mower 142 can be mounted thereto and thus a mower unit could comprise on a single beam one, two or more reel mowers 142.

In the illustrated embodiments, each of the right boom and the left boom have been illustrated with all portions of the beam disposed in the same flat plane. This is not necessary and it is to be appreciated that a boom need not lie in the same flat plane and it may advantageously in certain circumstances extend upwardly and downwardly as, for example, to assist in coupling the boom to the vehicle, to assist in locating a boom during normal operation in mowing the grass at a position to the side or front or to the rear of a reel mower 142 to provide a guard rail, and to assist in preventing the boom from engaging the ground during use.

The illustrated embodiments show one mechanism for mounting the reel mower gang to a vehicle. It is to be appreciated that various other mounting mechanisms may be provided which may nor may not provide for ease of detachment of the reel mower gang to the vehicle and may or may not provide for lifting of the reel mower gang.

The discussion of FIGS. 9 and 10 is focused on the manner of support and raising of each of the left and right booms. The center boom 180 is preferably coupled to each of the left and right booms such as, for example, near the pins 256 and 264, that when both the left and right booms become raised, the center boom also becomes raised. In the support mechanism for supporting the reel mower gang as illustrated, each of the three booms is indicated as being pivotable about the same horizontal boom axis 184. This is not necessary and each boom could be mounted for rotation about a boom axis which will parallel to each other need not be co-axial.

In accordance with one aspect of the present invention, a reel mower gang has reel mower 142 disposed within a guard rail assembly formed by portions of the various booms being disposed about the perimeter of the reel mower 142. Preferably, the guard rail assembly may be structured to assist in engaging an obstacle, such as, a tree to prevent damage to the reel mower and, as well, for deflection of any impact in a manner to minimize damage to the guard rail assembly. In this regard, as seen for example in FIG. 17, forward arm portions 219 and 229 of the right and left booms may be angled to assist in deflecting any impact laterally. The ability of the individual booms to pivot upwardly about the horizontal boom axis can serve as a force absorbing mechanism to minimize damage on impact to any obstacle.

FIG. 17 shows a center mower unit 174 with a center boom 180 which extends directly forwardly to support its reel mower 142. Each of the booms for the left and right mower units could similarly comprise a boom which extends directly forwardly and thus in the context of FIG. 17, the left and right booms could comprise booms similar to that shown as a center boom in FIG. 4. In such a configuration, the booms would not provide a guard rail assembly. If desired, a separate guard rail assembly could be provided. Such an independent guard rail assembly could be mounted to each of the booms and could, for example, be mounted so as to have a first segment joining the right boom to the center boom and a second segment joining the left boom to the center boom, coupled for pivoting in a manner to accommodate the raising of the individual booms independently. Providing a guard rail assembly is not however necessary.

The vehicle 10 shown in FIG. 1 includes as a feature of the crab coupling 16, the ability of the vehicle to pivot about the longitudinal axis 20. It is to be appreciated that this is not necessary and a similar vehicle would have utility which does not provide for pivoting about the axis 20 at the crab coupling 16.

The preferred vehicle in accordance with the present invention illustrates a take-off mechanism for attachments being coupled to the suspended front body 24. It is to be appreciated in accordance with the invention that any take-offs could also be coupled directly to the front carriage 26 and, therefore, not supported by the suspension.

The preferred embodiment of the mower gang shown in FIG. 5 has all three mower units mounted in front of the vehicle. In another embodiment, the center mower unit could be disposed to be mounted underneath the vehicle as between the front wheels and the left and front mower units could then be mounted forward the vehicle closer to the front end of the vehicle as, for example, in a manner not dissimilar to that shown in FIG. 17.

While the invention has been described with reference to preferred embodiments, many modifications and variations will now occur to persons skilled in the art. For a definition of the invention, reference is made to the following claims.

We claim:

1. A vehicle with a body comprising:
a lower deck extending along a longitudinal from a front end to a rear end and having left and right lateral sides,
an upper deck extending along a longitudinal from a front end to a rear end and having left and right lateral sides,
the upper deck is supported by a plurality of tubular rib members above the lower deck with the longitudinal of each aligned and with the upper deck spaced from the lower deck to define a cavity between the lower deck and the upper deck and within the rib members,
the rib members including left hand side ribs extending outwardly from the left hand side of the lower deck then upwardly and inwardly to the left hand side of the upper deck and right hand side ribs extending outwardly from the right hand side of the lower deck then upwardly and inwardly to the right hand side of the upper deck.

2. A vehicle as claimed in claim 1 wherein batteries to power the vehicle are supported on the lower deck in the space between the upper deck and the lower deck.

3. A vehicle as claimed in claim 2 wherein a steering wheel for the vehicle and an operator's seat are provided above the upper deck supported thereon.

4. A vehicle as claimed in claim 2 including a steering mechanism with a steering chain movable to steer the vehicle and extending between the front end and the rear end of the lower deck wherein the lower deck includes raceways extending parallel the longitudinal of the lower deck underneath the batteries,
the chain received within the lower deck in raceways.

5. A vehicle as claimed in claim 2 wherein the lower deck has a width between its left and right lateral sides which is not substantially greater than the width of a battery supported thereon.

6. A vehicle as claimed in claim 4 wherein the steering mechanism includes a front chain sprocket journalled on the front end of the lower deck forward of the batteries for engagement by the steering chain and a rear steering sprocket secured to the rear end of the lower deck rearward of the batteries for engagement by the steering chain.

7. A vehicle as claimed in claim 3 wherein a wheel carriage frame comprising two wheels supported in spaced apart relation on a common axle are mounted to the body via a pivotable connection for pivoting about an axis parallel the axle between the front end of the lower deck and the frame with a resilient axially deflectable strut member having an upper end coupled to the upper deck at its front end and a lower end coupled to the lower deck.

8. A reel mower gang assembly mountable to a vehicle to be moved forwardly by the vehicle to mow grass,
the assembly comprising an elongate boom having a first end and a second end,
the boom adapted to be mounted at a first end to the vehicle for pivoting about a generally horizontal first axis normal to a direction in which the vehicle is to move straightforwardly, p1 a reel type mower having two laterally spaced ground engaging wheels rotatable about a common wheel axis, the mower coupled to the second end of the boom for pivoting about a generally horizontal second axis normal to the first axis and for pivoting about a generally vertical third axis,
the vertical axis being substantially centered between the two wheels and forwardly of the wheel axis.

9. An assembly as claimed in claim 8 in which the boom and an associated reel type mower comprise a mower unit.

10. An assembly as claimed in claim 9 wherein the assembly includes a plurality of said mower units, the boom of each mower unit each being independently pivotable about its respective first axis and with the mower of each mower unit each being independently pivotable about its respective second and third axis.

11. An assembly as claimed in claim 10 wherein the plurality of mower units include a right hand mower unit and a left hand mower unit, the right hand mower unit is mounted laterally to a right hand side of the left hand mower unit laterally to the left hand side thereof,
the boom of the right hand mower unit extending from its first end forwardly past the right hand mower laterally to the right hand side of the right hand mower then laterally towards the left forward of the right hand mower to its second end where it is coupled to the right hand mower forwardly thereof, said right hand mower in pivoting about the second axis and third axis being maintained to the right and rearward of the right hand boom with the right hand boom providing protection to the right hand mower against impacts with articles disposed forward or to the right hand side of the right hand boom.

12. An assembly as claimed in claim 11 wherein the left hand mower unit is mounted laterally to a left hand side of the right hand mower unit laterally to the right hand side thereof,
the boom of the left hand mower unit extending from its first end forwardly past the left hand mower laterally to the left hand side of the left hand mower then laterally towards the right forward of the left hand mower to its second end where it is coupled to the left hand mower forwardly thereof, said left hand mower in pivoting about the second axis and third axis being maintained to the left and rearward of the left hand boom with the left hand boom providing protection to the left hand mower against impacts with articles disposed forward or to the left hand side of the left hand boom.

13. An assembly as claimed in claim 12 in which the second end of the right hand boom and the second end of the left hand boom are disposed laterally beside each other and are coupled together to resist relative movement forwardly or rearwardly or substantially side-to-side yet permit independent pivoting of each boom about its first axis.

14. An assembly as claimed in claim 13 including a boom linking rod extending from the second end of the right hand boom laterally to the second end of the left hand boom and coupled to each for pivoting about axes generally parallel the second axis.

15. An assembly as claimed in claim 14 in which the left hand side boom, the boom linking rod and the right hand side boom form a continuous guard rail assembly extending continuously across the front of the left and right mowers and laterally outwardly thereof.

16. An assembly as claimed in claim 15 including a center boom carrying a center mower disposed forwardly or rearwardly of both the right and left hand mowers and centered intermediate thereto.

17. An assembly as claimed in claim 16 in which the center mower is rearward of the left and right hand mowers and intermediate the lateral portions of the left and right hand booms.

18. A reel mower gang assembly having a plurality of reel type mowers coupled together in an array, a guard rail assembly encircling the array spaced outwardly from the array and coupled to the arrays so as to provide a guide barrier preventing impact of the mowers of the array with obstacles to be encountered in mowing a lawn.
